(19) United States
(12) Patent Application Publication
(10) Pub. No.: US 2022/0372709 A1
(43) Pub. Date: Nov. 24, 2022

(54) HIGH BARRIER PAPERBOARD AND PAPERBOARD CONTAINERS

(71) Applicant: WestRock MWV, LLC, Atlanta, CA (US)

(72) Inventors: Jiebin Pang, Glen Allen, VA (US); Yue Hu, Glen Allen, VA (US); William Statelman, Richmond, VA (US)

(21) Appl. No.: 17/642,814

(22) PCT Filed: Sep. 9, 2020
(86) PCT No.: PCT/US2020/049844

§ 371 Date: Mar. 14, 2022

Related U.S. Application Data
(60) Provisional application No. 62/899,786, filed on Sep. 13, 2019.

(51) Int. Cl. D21H 19/82; D21H 19/84; D21H 19/22; D21H 21/16; D21H 27/10; B32B 27/10; B32B 29/00; B32B 27/32; B32B 27/30

(52) U.S. Cl. CPC D21H 19/824; D21H 19/84; D21H 19/22; D21H 21/16; D21H 27/10; B32B 27/10; B32B 29/00; B32B 27/32; B32B 27/306; B32B 2307/732; B32B 2307/7244; B32B 2307/7246; B32B 2307/718

(57) ABSTRACT

A high barrier paperboard includes a paperboard substrate having a first major side and a second major side, at least one ethylene-vinyl alcohol layer on the first major side of the paperboard substrate, and at least one nucleated polyethylene layer on the first major side of the paperboard substrate.

### PRIORITY

This application claims priority from U.S. Ser. No. 62/899,786 filed on Sep. 13, 2019, the entire contents of which are incorporated herein by reference.

### FIELD

The present application relates to the field of high barrier paperboard and high barrier paperboard containers, in particular paperboard and paperboard containers with very high barrier properties to moisture and oxygen.

### BACKGROUND

There is a need for a very high barrier paperboard that has almost zero permeability to moisture and oxygen for food packaging applications requiring a long shelf-life. This can be currently achieved by lamination of paperboard with aluminum foil. However, there is also a trend to minimize or eliminate the use of foil in packaging. Thus, there is a need for a non-metalized paperboard having barrier properties comparable to paperboard laminated with aluminum foil.

Accordingly, those skilled in the art continue with research and development in the field of high barrier paperboard and high barrier paperboard containers.

### SUMMARY

In one embodiment, a high barrier paperboard includes a paperboard substrate having a first major side and a second major side. At least one ethylene-vinyl alcohol layer is on the first major side of the paperboard substrate. At least one nucleated polyethylene layer is also on the first major side of the paperboard substrate (e.g., on the ethylene-vinyl alcohol layer).

In another embodiment, a high barrier paperboard container is formed from at least one high barrier paperboard blank. The at least one high barrier paperboard blank includes a paperboard substrate having a first major side and a second major side. An ethylene-vinyl alcohol layer is on the first major side of the paperboard substrate. A nucleated polyethylene layer is on the ethylene-vinyl alcohol layer.

Other embodiments of the disclosed high barrier paperboard and high barrier paperboard containers will become apparent from the following detailed description, the accompanying drawings, and the appended claims.

### BRIEF DESCRIPTION OF THE DRAWINGS

FIG. 1 is a cross-sectional view of an exemplary high barrier paperboard according to present description.

FIG. 2 is a cross-sectional view of another exemplary high barrier paperboard according to present description.

FIG. 3 shows exemplary method of manufacturing a high barrier paperboard according to present description.

FIG. 4 is a cross-sectional view of another exemplary high barrier paperboard according to present description.

FIG. 5 is a cross-sectional view of another exemplary high barrier paperboard according to present description.

FIG. 6 shows exemplary method of manufacturing a high barrier paperboard according to present description.

FIG. 7 shows a schematic illustration of folded longitudinal end of an exemplary high barrier paperboard container of the present description.

FIG. 8 shows a schematic illustration of the formation of a container body, wherein the folded longitudinal end overlapped inside the other longitudinal end to form a body seam.

FIG. 9 shows an exemplary high barrier paperboard container, comprising a container body, a top lid, and a bottom.

### DETAILED DESCRIPTION

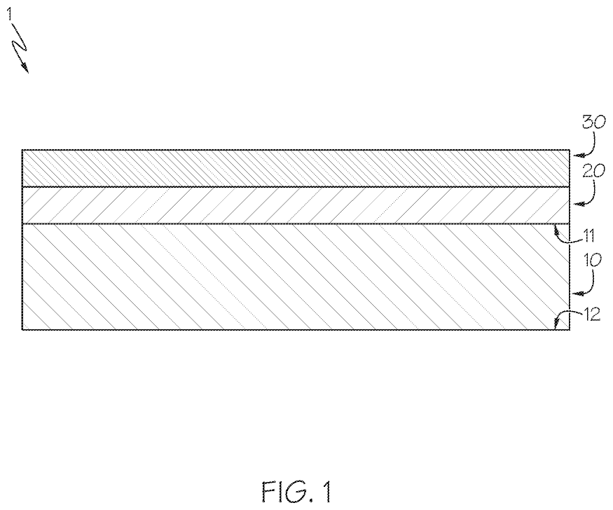

Referring to FIG. 1, the high barrier paperboard 1 includes a paperboard substrate 10 having a first major side 11 and a second major side 12, an ethylene-vinyl alcohol layer 20 on the first major side 11 of the paperboard substrate 10, and a nucleated polyethylene layer 30 on the ethylene-vinyl alcohol layer 20.

The paperboard substrate 10 should be suitable for forming into a paperboard container. The paperboard substrate 10 may include, for example, paperboard substrates selected from natural kraft board, solid bleached sulfate board, solid unbleached sulfate board, coated recycled board, coated white lined chipboard, and folding boxboard.

The thickness of the paperboard substrate 10 should be suitable for forming into a paperboard container. In an example, the paperboard substrate 10 may have a caliper thickness in a range of 6 points to 36 points. In another example, the paperboard substrate 10 may have a caliper thickness in a range of 12 points to 20 points. In yet another example, the paperboard substrate 10 may have a caliper thickness in a range of 16 points to 20 points.

The weight of the paperboard substrate 10 should be suitable for forming into a paperboard container. In an example, the paperboard substrate 10 may have a basis weight thickness in a range of 60 to 350 pounds per 3,000 square feet. In another example, the paperboard substrate 10 may have a basis weight in a range of 100 to 150 pounds per 3,000 square feet. In yet another example, the paperboard substrate 10 may have a basis weight in a range of 150 to 180 pounds per 3,000 square feet. In yet another example, the paperboard substrate 10 may have a basis weight in a range of 180 to 220 pounds per 3,000 square feet.

The ethylene-vinyl alcohol layer 20 is used as an oxygen barrier. In an example, an average thickness of the ethylene-vinyl alcohol layer 20 is in a range of 0.01 mil to 5 mil. In another example, the average thickness of the ethylene-vinyl alcohol layer 20 is in a range of 0.1 mil to 1 mil. In yet another example, the average thickness of the ethylene-vinyl alcohol layer 20 is in a range of 0.2 mil to 0.5 mil.

The nucleated polyethylene layer 30 functions as a moisture barrier. Suitable nucleated polyethylene for the nucleated polyethylene layer 30 comprises a nucleating agent and a polyethylene resin. Suitable polyethylene for making the nucleated polyethylene includes high-density polyethylene (HDPE). The high-density polyethylene may include ethylene homopolymers and copolymers of ethylene and α-olefins. Suitable α-olefins include 1-butene, 1-hexene, and 1-octene, the like, and mixtures thereof. Preferably, the α-olefin content in the nucleated HDPE is less than 2 wt %. The nucleated HDPE has a density preferably within the range of 0.940 to 0.970 g/cm³, and more preferably within the range of 0.945 to 0.965 g/cm³. The nucleated HDPE has a melt index MI₂ preferably within the range of 0.001 to 100 dg/min, and more preferably within the range of 0.05 to 50 dg/min. Density is measured according to ASTM D1505; and MI₂ is measured according to ASTM D 1238 at 190° C. and 2.16 kg. In an aspect, the nucleated polyethylene can be multimodal, meaning that the nucleated polyethylene comprises at least two components, one of which has a relatively low molecular weight, and the other which has a relatively high molecular weight.

Suitable nucleating agents include those nucleating agents known to the industry. In an example, the nucleating agent is selected from the group consisting of glycerol alkoxide salts, hexahydrophthalic acid salts, the like, and mixtures thereof. The salts include ammonium and metal salts. In an example, the glycerol alkoxide salt is selected from the group consisting of zinc, magnesium, and calcium glycerolates and mixtures thereof. In an example, the hexahydrophthalic acid salt is selected from the group consisting of zinc, magnesium, and calcium hexahydrophthalates, the like, and mixtures thereof. Many glycerol alkoxide salts and hexahydrophthalic acid salts are commercially available. The amount of nucleating agent used varies depending on many factors such as the nucleating agent type, the properties of the polyethylene layer 30, and the targeted improvement of the barrier properties. In an example, the nucleating agent is used in an amount within the range of 0.01 to 1 wt % of the polyethylene layer 30. In another example, the amount of the nucleating agent is within the range of 0.05 to 0.5 wt % of the polyethylene layer 30.

In an example, an average thickness of the nucleated polyethylene layer 30 is in a range of 0.01 mil to 10 mil. In another example, the average thickness of the nucleated polyethylene layer 30 is in a range of 0.1 mil to 1 mil. In yet another example, the average thickness of the nucleated polyethylene layer 30 is in a range of 0.5 mil to 0.9 mil.

By positioning the nucleated polyethylene layer 30 on the ethylene-vinyl alcohol layer 20 or at the side with higher humidity, moisture penetration to the ethylene-vinyl alcohol layer 20 is prevented or minimized. Preventing or minimizing moisture penetration to the ethylene-vinyl alcohol layer 20 is important because moisture has a detrimental effect on the oxygen barrier properties of the ethylene-vinyl alcohol layer 20. Combining the excellent moisture barrier properties of the nucleated polyethylene layer 30 with the excellent oxygen barrier properties of the ethylene-vinyl alcohol layer 20 provides for a paperboard having excellent moisture and oxygen barrier properties

Furthermore, the ethylene-vinyl alcohol layer 20 may be oxygen scavenging ethylene-vinyl alcohol layer 20. The oxygen scavenging ethylene-vinyl alcohol layer is an ethylene-vinyl alcohol including an oxygen scavenging agent. The oxygen scavenging agent functions by scavenging oxygen passing through the ethylene-vinyl alcohol layer 20. Suitable oxygen scavenging agents include oxygen-scavenging polymers known to the industry.

By including an oxygen scavenging ethylene-vinyl alcohol layer 20 and a nucleated polyethylene layer 30, a very high barrier paperboard without using any metal layer is achievable. Indeed, high barrier paperboard with an OTR (oxygen transmission rate) of 0 cc/m2-day and a WVTR (water vapor transmission rate) of <1 g/m2-day has been demonstrated by combining an oxygen scavenging ethylene-vinyl alcohol with a nucleated high-density polyethylene layer onto a paperboard substrate, thus achieving barrier properties comparable to paperboard laminated with aluminum foil.

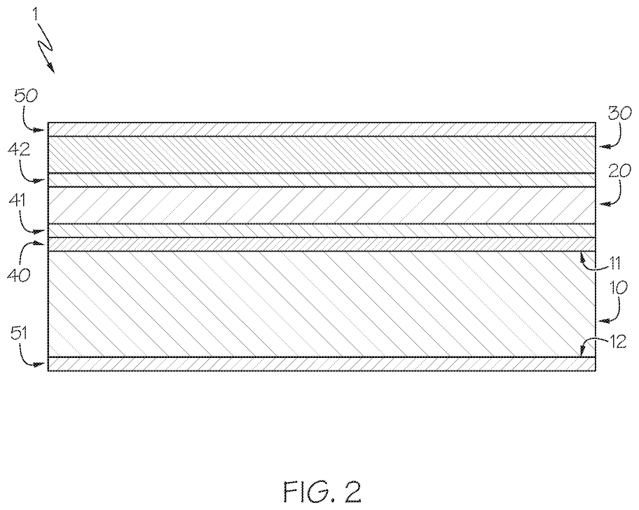

The high barrier paperboard 1 may include one or more additional layers in addition to the ethylene-vinyl alcohol layer 20 and the nucleated polyethylene layer 30. For example, as illustrated in FIG. 2, the high barrier paperboard 1 may include one or more polymer or tie layers between the paperboard substrate 10 and the ethylene-vinyl alcohol layer 20. In an aspect, the high barrier paperboard 1 may include at least a first polymer or tie layer 40 and a second tie layer 41 between the paperboard substrate 10 and the ethylene-vinyl alcohol layer 20. The first polymer or tie layer 40 may function to adhere to the paperboard substrate 10. Suitable materials for the first polymer or tie layer 40 include polyethylene, particularly low-density polyethylene. The second tie layer 41 may function to improve adhesion between the first polymer or tie layer 40 and the ethylene-vinyl alcohol layer 20. Suitable materials for the second tie layer 41 include anhydride modified polyethylene. Additional polymer layers between the paperboard substrate 10 and the ethylene-vinyl alcohol layer 20 may be included.

The high barrier paperboard 1 may include one or more polymer or tie layers between the ethylene-vinyl alcohol layer 20 and the nucleated polyethylene layer 30. In an aspect, the high barrier paperboard 1 may include at least a third tie layer 42 between the ethylene-vinyl alcohol layer 20 and the nucleated polyethylene layer 30. The third tie layer 42 may function to improve adhesion between the ethylene-vinyl alcohol layer 20 and the nucleated polyethylene layer 30. Suitable materials for the third tie layer 42 include anhydride modified polyethylene. Additional polymer layers between the ethylene-vinyl alcohol layer 20 and the nucleated polyethylene layer 30 may be included.

The high barrier paperboard 1 may include a first sealant layer 50 on the nucleated polyethylene layer 30. The first sealant layer 50 functions by softening at a low temperature, so that the high barrier paperboard can be heat sealed. Suitable materials for the first sealant layer 50 include low-density polyethylene. Additional layers on the nucleated polyethylene layer 30 may be included.

The high barrier paperboard 1 may include a second sealant layer 51 on the second major side 12 of the paperboard substrate 10. The second sealant layer 51 functions by softening at a low temperature, so that the high barrier paperboard can be heat sealed with a strong bond. This polymer sealant layer 51 that often faces outside of the paperboard container, can also protect the container from damage, such as becoming soggy by moisture, and can provide high print quality. Suitable materials for the second sealant layer 51 include low-density polyethylene. Additional polymer layers on the second major side 12 of the paperboard substrate 10 may be included.

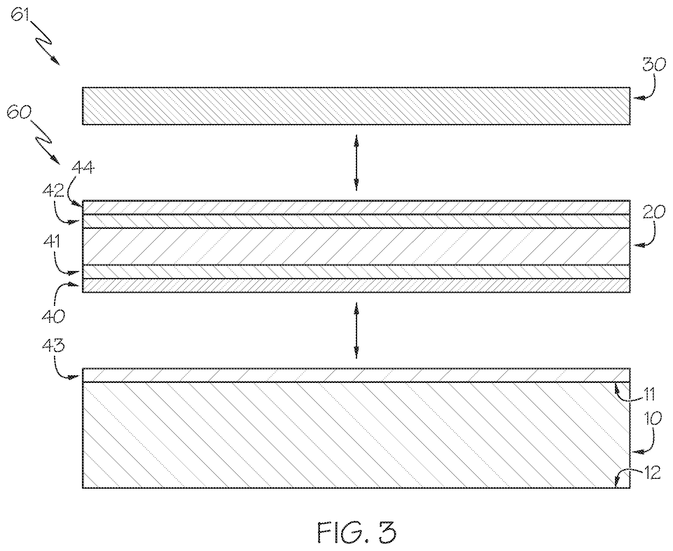

Referring to FIG. 3, a high barrier paperboard 1 may be manufactured, for example, by laminating a first film 60 and a second film 61 onto the paperboard substrate 10. The structure of the exemplary high barrier paperboard of FIG. 3 is similar to the exemplary high barrier paperboard of FIG. 2, except for additional layers to facilitate the laminating process. Also, the first sealant layer 50 and the second sealant layer 51 are not shown in FIG. 3. It will be understood that the first sealant layer 50 and the second sealant layer 51 can be applied prior to, during, or after laminating the first film 60 and the second film 61 onto the paperboard substrate 10.

As shown in FIG. 3, the high barrier paperboard 1 may include a fourth tie layer 43 on the first major side 11 of the paperboard substrate 10. The fourth tie layer 43 facilitates sealing the first film 60 to the paperboard substrate 10. The fourth tie layer 43 functions by softening at a low temperature, so that the first film 60 can be bonded to the paperboard substrate 10. Suitable materials for the fourth tie layer 43 include low-density polyethylene.

As further shown in FIG. 3, the high barrier paperboard 1 may include a fifth tie layer 44 on the third polymer or tie layer 42. The fifth tie layer 44 facilitates sealing the first film 60 to the second film 61. The fifth tie layer 44 functions by softening at a low temperature, so that the second film 61 can be bonded to the first film 60. Suitable materials for the fifth tie layer 44 include low-density polyethylene.

An experimental high barrier paperboard 1 was formed by lamination as shown in FIG. 3. The paperboard substrate 10 was 16.5 point solid bleached sulfate board. A 0.75-mil low-density polyethylene, Petrothene™ NA217000, Equistar Chemicals, LP, was provided on the first major side 11 of the paperboard substrate 10.

The first film 60 was a 3-mil polyethylene co-extruded film containing an oxygen scavenging ethylene-vinyl alcohol layer. More specifically, the first film 60 included 0.3-mil layer of oxygen scavenging ethylene-vinyl alcohol sandwiched between opposing 0.15-mil tie layers, all of which is sandwiched between by a 0.6-mil layer of low-density polyetheylene, all of which is sandwiched between by a 0.6-mil layer of linear low-density polyetheylene. The 0.3-mil layer of oxygen scavenging ethylene-vinyl alcohol was EVAL® XEP-1191 from Kuraray America Inc. The 0.15-mil tie layers were Dow 611/NF498 70/30; DOW™ 611 resin from Dow Chemical, ADMER™ NF498E (maleic anhydride grafted LLDPE-based resin) from Mitsui Chemicals. The 0.6-mil layers of low-density polyetheylene was DOW™ 611 resin from Dow Chemical. The 0.6-mil layers of linear low-density polyetheylene was DOWLEX® 2056 from Dow Chemical.

The second film 61 was 2-mil nucleated high-density polyethylene film, Alathon® M6010SB, Equistar Chemicals, LP. The first film 60 and second film 61 were laminated on the paperboard substrate 10 with a Banner American, PL 135-4 laminator.

As described in Table 1 below, the resulting paperboard had an OTR (oxygen transmission rate) of 0 cc/m2-day and a WVTR (water vapor transmission rate) of <1 g/m2-day by combining oxygen scavenging ethylene-vinyl alcohol with a nucleated high-density polyethylene film onto paperboard. WVTR was measured on an Illinois Instruments, Model 7012, Water Vapor Permeation Analyzer. OTR was measured on an Illinois Instruments, Model 8011, Oxygen Permeation Analyzer-Expansion Module.

TABLE 1

| | Barrier Properties | |
|---|---|---|
| | WVTR@ 90% | OTR @ 0% RH, |
| | RH, 38° C. | 23° C., 100% O2 |
| | (g/m²-day) | (cc/m²-day) |
| Results | 0.75 | 0.00 |

This demonstrates a very high barrier paperboard with comparable barrier performance to paperboard laminated with aluminum foil that has almost zero permeability to all molecules including moisture and oxygen. WVTR and OTR values were expected to be same or similar if the 2-mil nucleated HDPE film was laminated first on the paperboard substrate 10 followed by the 3-mil polyethylene co-extruded film containing an oxygen scavenging ethylene-vinyl alcohol layer.

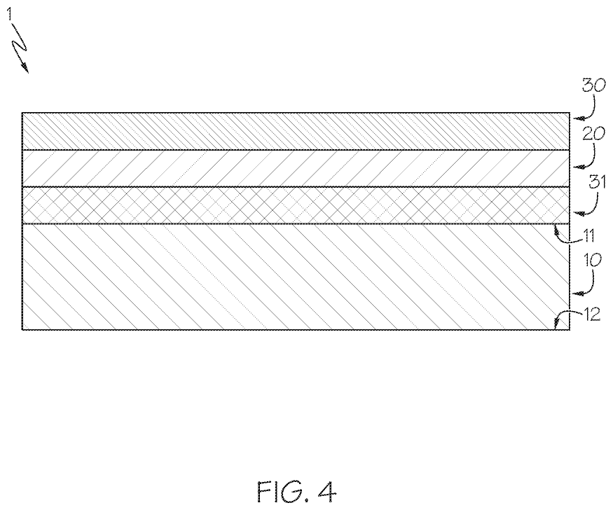

The high barrier paperboard 1 may include one or more additional layers in addition to the ethylene-vinyl alcohol layer 20 and the nucleated polyethylene layer 30. For example, as illustrated in FIG. 4, the high barrier paperboard 1 may include a second nucleated polyethylene layer 31 between the paperboard substrate 10 and the ethylene-vinyl alcohol layer 20.

The second nucleated polyethylene layer 31 functions as a moisture barrier. The nucleated polyethylene for the second nucleated polyethylene layer 31 may be the same or different from that of the first nucleated polyethylene layer 30. Suitable nucleated polyethylene for the second nucleated polyethylene layer 31 comprises a nucleating agent and a polyethylene resin. Suitable polyethylene for making the nucleated polyethylene includes high-density polyethylene (HDPE). The high-density polyethylene may include ethylene homopolymers and copolymers of ethylene and α-olefins. Suitable α-olefins include 1-butene, 1-hexene, and 1-octene, the like, and mixtures thereof. Preferably, the α-olefin content in the nucleated HDPE is less than 2 wt %. The nucleated HDPE has a density preferably within the range of 0.940 to 0.970 g/cm³, and more preferably within the range of 0.945 to 0.965 g/cm³. The nucleated HDPE has a melt index MI₂ preferably within the range of 0.001 to 100 dg/min, and more preferably within the range of 0.05 to 50 dg/min. Density is measured according to ASTM D1505; and MI₂ is measured according to ASTM D 1238 at 190° C. and 2.16 kg. In an aspect, the nucleated polyethylene can be multimodal, meaning that the nucleated polyethylene comprises at least two components, one of which has a relatively low molecular weight, and the other which has a relatively high molecular weight.

Suitable nucleating agents include those nucleating agents known to the industry. In an example, the nucleating agent is selected from the group consisting of glycerol alkoxide salts, hexahydrophthalic acid salts, the like, and mixtures thereof. The salts include ammonium and metal salts. In an example, the glycerol alkoxide salt is selected from the group consisting of zinc, magnesium, and calcium glycerolates and mixtures thereof. In an example, the hexahydrophthalic acid salt is selected from the group consisting of zinc, magnesium, and calcium hexahydrophthalates, the like, and mixtures thereof. Many glycerol alkoxide salts and hexahydrophthalic acid salts are commercially available. The amount of nucleating agent used varies depending on many factors such as the nucleating agent type, the properties of the polyethylene layer 30, and the targeted improvement of the barrier properties. In an example, the nucleating agent is used in an amount within the range of 0.01 to 1 wt % of the polyethylene layer 30. In another example, the amount of the nucleating agent is within the range of 0.05 to 0.5 wt % of the polyethylene layer 30.

In an example, an average thickness of the second nucleated polyethylene layer 31 may be the same or different from that of the first nucleated polyethylene layer 30. The average thickness of the second nucleated polyethylene layer 31 is in a range of 0.01 mil to 10 mil. In another example, the average thickness of the second nucleated polyethylene layer 31 is in a range of 0.1 mil to 1 mil. In yet another example, the average thickness of the second nucleated polyethylene layer 31 is in a range of 0.5 mil to 0.9 mil.

By positioning the second nucleated polyethylene layer 31 between the paperboard substrate 10 and the ethylene-vinyl alcohol layer 20, moisture penetration to the ethylene-vinyl alcohol layer 20 further is prevented or minimized. Preventing or minimizing moisture penetration to the ethylene-vinyl alcohol layer 20 is important because moisture has a detrimental effect on the oxygen barrier properties of the ethylene-vinyl alcohol layer 20. Furthermore, combining the excellent moisture barrier properties of the nucleated polyethylene layer 30, the second nucleated polyethylene layer 31 with the excellent oxygen barrier properties of the ethylene-vinyl alcohol layer 20 provides for a high barrier paperboard having excellent moisture and oxygen barrier properties

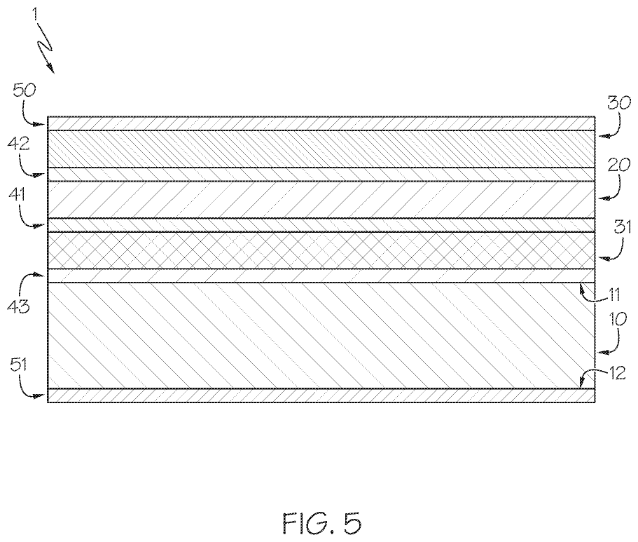

Referring to FIG. 5, the high barrier paperboard 1 may include one or more tie layers between the second nucleated polyethylene layer 31 and the ethylene-vinyl alcohol layer 20. In an aspect, the high barrier paperboard 1 may include at least the second tie layer 41 between the second nucleated polyethylene layer 31 and the ethylene-vinyl alcohol layer 20. The second tie layer 41 may function to improve adhesion between the second nucleated polyethylene layer 31 and the ethylene-vinyl alcohol layer 20. Suitable materials for the second tie layer 41 include anhydride modified polyethylene. Additional layers between the second nucleated polyethylene layer 31 and the ethylene-vinyl alcohol layer 20 may be included.

Referring to FIG. 5, the high barrier paperboard 1 may further include one or more tie layers between the paperboard substrate 10 and the second nucleated polyethylene layer 31. The high barrier paperboard 1 may include the fourth tie layer 43 between the paperboard substrate 10 and the second nucleated polyethylene layer 31. The fourth tie layer 43 facilitates bonding the second nucleated polyethylene layer 31 to the paperboard substrate 10. The fourth tie layer 43 functions by softening at a low temperature, so that the second nucleated polyethylene layer 31 can be bonded to the paperboard substrate 10. Suitable materials for the fourth tie layer 43 include low-density polyethylene.

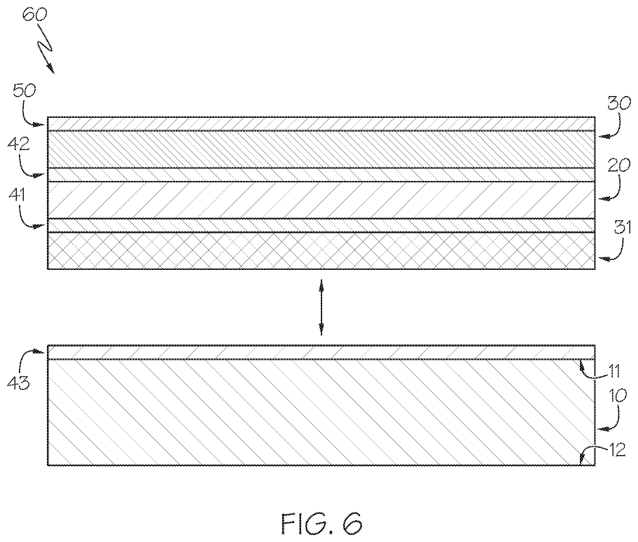

A high barrier paperboard 1 may be manufactured, for example, by laminating a first film 60 onto the paperboard substrate 10, such as shown in FIG. 6. In FIG. 6, the first film 60 includes the ethylene-vinyl alcohol layer 20, the first nucleated polyethylene layer 30, the second nucleated polyethylene layer 31, the second tie layer 41 between the second nucleated polyethylene layer 31 and the ethylene-vinyl alcohol layer 20, the third tie layer 42 between the ethylene-vinyl alcohol layer 20 and the nucleated polyethylene layer 30, and the first sealant layer 50. The second sealant layer 51 is not shown in FIG. 6. It will be understood that the second sealant layer 51 can be applied prior to, during, or after laminating the first film 60 onto the paperboard substrate 10. Also, it will be understood that the first sealant layer 50 can be applied prior to, during, or after laminating the first film 60 onto the paperboard substrate 10.

An experimental high barrier paperboard 1 was formed by lamination as shown in FIG. 6. The paperboard substrate 10 was 16.5 point solid bleached sulfate board. A 0.5-mil and 0.75-mil low-density polyethylene, Petrothene™ NA217000, Equistar Chemicals, LP, were provided on the first major side 11 and the second major side 12 of the paperboard substrate 10, respectively.

The first film 60 was a 3.25-mil co-extruded film containing ethylene-vinyl alcohol film and nucleated polyethylene. More specifically, the first film 60 included 0.37-mil layer of ethylene-vinyl alcohol sandwiched between opposing 0.315-mil tie layers, all of which is sandwiched between by 0.75-mil nucleated high-density polyethylene layers. One of the nucleated high-density polyethylene layers included an additional sealant layer. More specifically, the 0.37-mil layer of ethylene-vinyl alcohol was SoarnoL™ DT2904RB, Nippon Gohsei. The 0.3-mil tie layers were Plexar® PX3236, (anhydride modified LLDPE), Equistar Chemicals, LP. The nucleated high-density polyethylene layers were Alathon M6010SB, Equistar Chemicals, LP. The sealant layer was low-density polyethylene, Petrothene™ NA205000, Equistar Chemicals, LP.

As described in Table 2 below, the resulting paperboard had an OTR (oxygen transmission rate) of <1 cc/m2-day and a WVTR (water vapor transmission rate) of <1 g/m2-day by combining ethylene-vinyl alcohol with a nucleated high-density polyethylene film onto paperboard.

TABLE 2

| | Barrier Properties | |
|---|---|---|
| | WVTR@ 90% | OTR @ 0% RH, |
| | RH, 38° C. | 23° C., 100% O2 |
| | (g/m²-day) | (cc/m²-day) |
| Results | 0.70 | 0.40 |

This also demonstrates a very high barrier paperboard with comparable barrier performance to paperboard laminated with aluminum foil that has almost zero permeability to all molecules including moisture and oxygen.

The resulting high barrier paperboard was formed into a 11.5 oz hermetically sealed cup as described below.

Referring to Table 3 below, the resulting high barrier paperboard cup had an OTR (oxygen transmission rate) of nearly zero and a low WVTR (water vapor transmission rate).

TABLE 3

| | Barrier Properties | |
|---|---|---|
| | WVTR@ 90% | OTR @ 50% RH, |
| | RH, 38° C. | 23° C., 21% O2 |
| | (g/package-day) | (cc/package-day) |
| 11.5 oz hermetically | 0.008 | 0.025 |
| sealed cup | | |

This demonstrates a very high barrier paperboard cup with comparable barrier performance to cups containing an aluminum foil layer that has almost zero permeability to all molecules including moisture and oxygen.

Although film lamination process was used in the examples of high barrier paperboard, a multi-layer co-extrusion coating process can be used to achieve similar paperboard structure for similar high barrier performance.

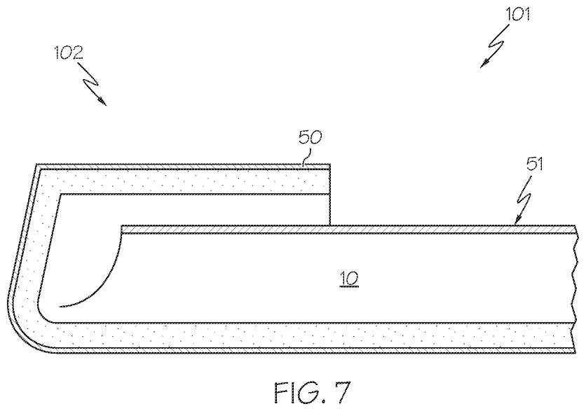

Referring to FIGS. 7 to 9, a high barrier paperboard container 100 (e.g. high barrier paperboard cup) may be formed from at least one high barrier paperboard blank of the high barrier paperboard 1 of the present description. The high barrier paperboard container 100 may be formed from the at least one high barrier paperboard blank 101 by any method of forming a high barrier paperboard container. An exemplary method is described as follows.

The high barrier paperboard 1 of the present description may be die cut to a desired silhouette to provide a high barrier paperboard blank 101 including a first longitudinal end 102 and a second longitudinal end 103. The first longitudinal end 102 of the high barrier paperboard blank 101 may be skived to a predetermined thickness for a predetermined width. The resulting skived end of the high barrier paperboard blank 101 may be treated with heat, then folded and sealed over the high barrier paperboard blank 101 to provide the folded first longitudinal end 102, as shown in FIG. 7. Thus, the first sealant layer 50 at the first major side 11 of the paperboard substrate 10 wraps around the skived end of the high barrier paperboard blank 101. The first sealant layer 50 may define an interior of the high barrier paperboard container and the second sealant layer 51 may define an exterior of the high barrier paperboard container.

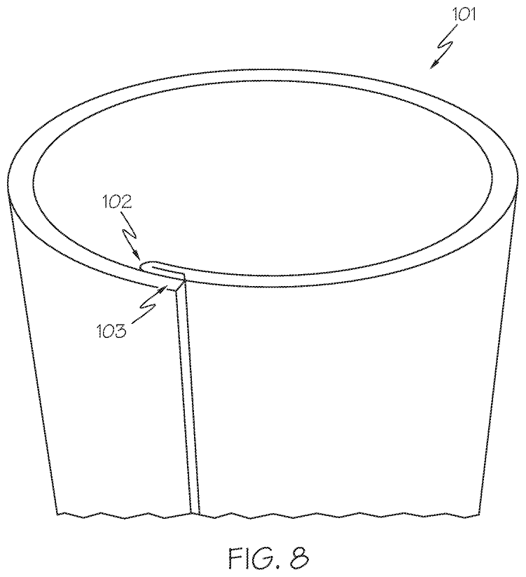

Referring to FIG. 8, a container body of the high barrier paperboard container is formed from the high barrier paperboard blank 101 by overlapping both longitudinal ends of the high barrier paperboard blank such that a folded first longitudinal end 102 is inside the second longitudinal end 103, and subsequently the overlapped seam is sealed.

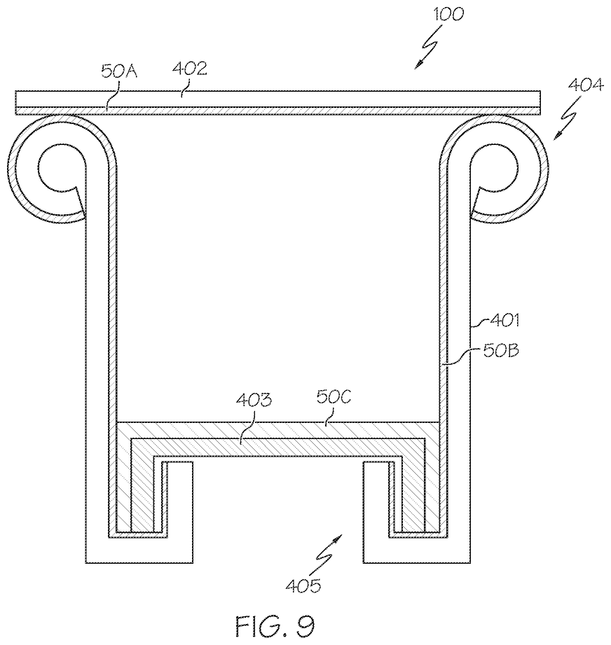

Referring to FIG. 9, a lid component may also be formed from at least one high barrier paperboard blank of the high barrier paperboard 1 of the present description. When desired, the lid component may be made of the same or similar material as that for the container body. Several methods may be used for sealing the lid component to the container body. Example of such seals include, but are not limited to, hermetically sealing the top with a plastic rim; a sealant bead dropped at the step-down area; a sealant bead added to the entire top rim before lidding; a lidding material with a heavy sealant such as those lidding films used for sealing barrier trays; a higher sealing pressure to press down lidding material to flatten the rim for maximum seal; and combinations thereof.

In one aspect of the present description, a bottom component of the high barrier paperboard container may also be formed from at least one high barrier paperboard blank of the high barrier paperboard 1 of the present description. When desired, the bottom component may be made of the same or similar material as that for the container body. The bottom may be assembled to the container body by various sealing technologies. Examples of such sealing may include, but not limited to, hot air heat seal and ultrasound sealing. The sealing process may be optimized based on various factors. Some of these factors include, but are not limited to, the thickness of the sealant layer on the bottom; and the processing conditions such as lower sealing temperature to prevent the formation of pinhole, and higher sealing pressure to minimize the formation of gap between the bottom and the body.

After formation of the container body, the configuration of the upper and lower ends of the body may be constructed to support the sealing with the lid and the bottom components. Any known configurations for the upper and lower ends of the container body may be used in the present disclosure, and the selection of such configuration depends on the desired packaging applications of the container. Example of the configurations for the upper and lower ends of the container body include, but are not limited to, recessed structure, rolled bead, flange, and combinations thereof.

FIG. 9 shows one embodiment of the high barrier paperboard container 100 of the present disclosure. The paperboard container 100 includes a body 401, a lid component 402, and a bottom component 403. The top end of the body 401 is rolled over so as to form a bead or flange 404, while the bottom end of the body 401 is constructed into a recessed configuration 405. The lid component 402 is hermetically sealed onto the upper end of the body 401 at the processing conditions that provide the adhesion between the sealant layer 50A of the lid component 402 and the first sealant layer 50B of the body 401. The bottom component 403 is placed and sealed into the recessed end of the body 401 so that there is adhesion between the sealant layer 50C of the bottom component 403 and the first sealant layer 50B of the body 401, and the sealant completely fills any gap between the bottom component 403 and the body 401.

Although various embodiments of the disclosed high barrier paperboard and high barrier paperboard containers have been shown and described, modifications may occur to those skilled in the art upon reading the specification. The present application includes such modifications and is limited only by the scope of the claims.

1. A high barrier paperboard comprising:
a paperboard substrate ROI having a first major side and a second major side;
at least one ethylene-vinyl alcohol layer on the first major side of the paperboard substrate; and
at least one nucleated polyethylene layer on the first major side of the paperboard substrate ROI.

2. The high barrier paperboard of claim 1 having an OTR of <2 cc/m2-day at 0% RH, 23° C., 100% O₂, and a WVTR of <2 g/m²-day at 90% RH, 38° C.

3. The high barrier paperboard of claim 1 having an OTR of <1 cc/m2-day at 0% RH, 23° C., 100% O₂, and a WVTR of <1 g/m²-day at 90% RH, 38° C.

4-11. (canceled)

12. The high barrier paperboard of claim 1 wherein the ethylene-vinyl alcohol layer is an oxygen-scavenging ethylene-vinyl alcohol layer.

13. The high barrier paperboard of claim 1 wherein an average thickness of the ethylene-vinyl alcohol layer is in a range of 0.01 mil to 5 mil.

14. The high barrier paperboard of claim 1 wherein an average thickness of the ethylene-vinyl alcohol layer is in a range of 0.1 mil to 1 mil.

15. (canceled)

16. The high barrier paperboard of claim 1 wherein the nucleated polyethylene layer is a nucleated high-density polyethylene layer.

17. The high barrier paperboard of claim 1 wherein an average thickness of the nucleated polyethylene layer is in a range of 0.01 mil to 10 mil.

18. The high barrier paperboard of claim 1 wherein an average thickness of the nucleated polyethylene layer is in a range of 0.1 mil to 1 mil.

19. (canceled)

20. The high barrier paperboard of claim 1 further comprising at least a first tie layer between the paperboard substrate and the ethylene-vinyl alcohol layer.

21. The high barrier paperboard of claim 20 wherein the first tie layer comprises polyethylene.

22. The high barrier paperboard of claim 20 further comprising at least a second tie layer between the first tie layer and the ethylene-vinyl alcohol layer.

23. The high barrier paperboard of claim 22 wherein the second tie layer comprises anhydride modified polyethylene.

24. The high barrier paperboard of claim 22 further comprising at least a third tie layer between the ethylene-vinyl alcohol layer and the nucleated polyethylene layer.

25. The high barrier paperboard of claim 24, wherein the third tie layer comprises anhydride modified polyethylene.

26. The high barrier paperboard of claim 1 further comprising a first sealant layer as the outermost layer on the first major side of the paperboard substrate.

27. The high barrier paperboard of claim 26 wherein the first sealant layer includes low-density polyethylene.

28. The high barrier paperboard of claim 1 further comprising a second sealant layer on the second major side of the paperboard substrate.

29. The high barrier paperboard of claim 28 wherein the second sealant layer includes low-density polyethylene.

30. A high barrier paperboard container being formed from at least one high barrier paperboard blank, the at least one high barrier paperboard blank comprising:
a paperboard substrate having a first major side and a second major side;
at least one ethylene-vinyl alcohol layer on the first major side of the paperboard substrate; and
at least one nucleated polyethylene layer on the first major side of the paperboard substrate.

31-58. (canceled)
